(19) United States
(12) Patent Application Publication
(10) Pub. No.: US 2026/0229769 A1
(43) Pub. Date: Aug. 6, 2026

(54) APPARATUS AND METHOD FOR ANTENNA BEAM ALIGNMENT

(71) Applicant: Nokia Technologies Oy, Espoo (FI)

(72) Inventors: Juha Samuel HALLIVUORI, Tampere (FI); Mikko KOMULAINEN, Oulu (FI); Ronny PEETERS, Antwerp (BE)

(21) Appl. No.: 19/456,452

(22) Filed: Jan. 22, 2026

(30) Foreign Application Priority Data
Feb. 3, 2025 (FI) 20255081

(51) Int. Cl. H01Q 3/02; H01Q 3/38

(52) U.S. Cl. CPC H01Q 3/02; H01Q 3/385

(57) ABSTRACT

Embodiments of the present disclosure relate to an apparatus, method, and computer program for antenna beam alignment of a rotatable antenna. The apparatus measures radio frequency (RF) signal strength of one or more sectors with a RF power detector, such as a sensor or measurement antenna. The apparatus determines at least one first sector of the one or more sectors based on the measured RF signal strength of the one or more sectors. Directivity of the RF power detector is lower than directivity of the rotatable antenna.

### FIELD

Embodiments of the present disclosure generally relate to the field of wireless communication, and in particular to a device, method, apparatus and a computer program for antenna beam alignment.

### BACKGROUND

A communication network can be seen as a facility that enables communications between two or more communication devices, or provides communication devices access to a data network. A mobile or wireless communication network is one example of a communication network.

Such communication networks operate in accordance with standards, such as those promulgated by the third generation partnership project (3GPP) or the European telecommunications standards institute (ETSI). Examples of such standards include the so-called 5th generation (5G) standard, 6th generation (6G), or other standards promulgated by 3GPP.

### SUMMARY

In general, example embodiments of the present disclosure provide devices, methods and a computer program for antenna beam alignment.

In a first aspect, there is provided an apparatus. The apparatus comprises: a RF power detector such as a sensor or antenna; and a rotatable antenna, wherein directivity of the RF power detector is lower than directivity of the rotatable antenna. The apparatus also includes a processor and memory storing instructions that, when executed by the processor, cause the apparatus to measure radio frequency (RF) signal strength of a plurality of sectors with the RF power detector; determine a first sector of the plurality of sectors based on the measured RF signal strength of the plurality of sectors; and perform an antenna rotation-based beam alignment scan for the first sector with the rotatable antenna.

In some embodiments, the first sector is a sector of the plurality sectors with the highest measured RF signal strength. In other embodiments, the first sector is determined based on the measured RF signal strength of the first sector being higher than a threshold.

In some embodiments, a sector of the plurality of sectors is placed with the RF power detector.

In some embodiments, the RF power detector is configured to rotate to a sector of the one or more sectors to measure RF signal strength of the sector, and is placed in a rotatable part of the rotatable antenna.

In some embodiments, RF power detector includes a boresight direction that is aligned with a boresight direction of the rotatable antenna.

In some embodiments, the measurement or the beam alignment scan is performed in an idle mode or an attached mode, or the measurement is performed without attaching to a network.

In some embodiments, the RF power detector comprises multiple antenna elements that form a ring array, wherein a sector of the plurality of sectors is measured with a subset of the multiple antenna elements.

In some embodiments, the size of the plurality of sectors measured with subset of the multiple antenna elements is adjusted depending on the number of multiple antenna elements included in the subset of multiple antenna elements.

In some embodiments, a radio system for the RF power detector and a radio system for the rotatable antenna are the same or at least partially different.

In some embodiments, the apparatus further switches between the radio system for the RF power detector and the radio system for the rotatable antenna during a RF signal loss or a connection failure.

In some embodiments, the RF power detector further comprises a diversity or a MIMO antenna of the rotatable antenna.

In some embodiments, the RF power detector is further configured to serve as a main or a secondary transceiver.

In some embodiments, the RF power detector is adjustable for operating frequency based on channel or frequency information.

In a second aspect, there is provided a method implemented at an apparatus. The apparatus comprises measuring the RF signal strength of each of a plurality of sectors with a RF power detector such as a sensor or antenna; determining, a first sector of the plurality of sectors based on the measured RF signal strength of each of the plurality of sectors; and performing an antenna rotation-based beam alignment scan for the first sector with a rotatable antenna, wherein directivity of the RF power detector is lower than directivity of the rotatable antenna.

In a third aspect, there is provided a computer program. The computer program comprises instructions which, when executed by an apparatus, cause the apparatus to perform the method according to the second aspect above.

In a fourth aspect, there is provided a non-transitory computer readable medium. The non-transitory computer readable medium comprises program instructions for causing user equipment to perform the method according to the second aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1 illustrates an example network environment in which some embodiments of the present disclosure can be implemented;

FIG. 2 illustrates a flowchart of an example method according to some embodiments of the present disclosure;

FIG. 3 illustrates an example of an apparatus according to some embodiments of the present disclosure;

FIG. 4 illustrates a diagram of a sensor that can be used as a RF power detector according to some embodiments of the present disclosure;

FIG. 5 illustrates an example top view diagram of an apparatus according to some embodiments of the present disclosure;

FIG. 6A illustrates an example top view diagram of an apparatus according to some embodiments of the present disclosure;

FIG. 6B illustrates an example top view diagram of an apparatus according to some embodiments of the present disclosure;

FIG. 7 illustrates a flowchart of an example method according to some embodiments of the present disclosure;

FIG. 8 illustrates a flowchart of an example method according to some embodiments of the present disclosure;

FIG. 9 illustrates a diagram of a sensor that can be used as a RF power detector according to some embodiments of the present disclosure;

FIG. 10 illustrates an example of an apparatus according to some embodiments of the present disclosure;

FIG. 11A illustrates an example of an apparatus according to some embodiments of the present disclosure;

FIG. 11B illustrates an example of an apparatus according to some embodiments of the present disclosure;

FIG. 12 illustrates an example of an antenna that can be used as a RF power detector according to some embodiments of the present disclosure;

FIG. 13 illustrates an example top view diagram of an apparatus according to some embodiments of the present disclosure;

FIG. 14A illustrates an example top view diagram of an apparatus according to some embodiments of the present disclosure;

FIG. 14B illustrates an example top view diagram of an apparatus according to some embodiments of the present disclosure;

FIG. 15 illustrates a flowchart of an example method according to some embodiments of the present disclosure;

FIG. 16 illustrates a flowchart of an example method according to some embodiments of the present disclosure;

FIG. 17 illustrates an example of an antenna that can be used as a rotatable antenna according to some embodiments of the present disclosure;

FIG. 18 illustrates an example of an apparatus according to some embodiments of the present disclosure;

FIG. 19 illustrates a flowchart of an example method according to some embodiments of the present disclosure;

FIG. 20 illustrates a simplified block diagram of an apparatus that is suitable for implementing embodiments of the present disclosure; and

FIG. 21 illustrates a block diagram of an example computer readable medium in accordance with some embodiments of the present disclosure.

Throughout the drawings, the same or similar reference numerals represent the same or similar elements.

### DETAILED DESCRIPTION

Principles of the present disclosure will now be described with reference to some example embodiments. It is to be understood that these embodiments are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skill in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as long term evolution (LTE), LTE-advanced (LTE-A), wideband code division multiple access (WCDMA), high-speed packet access (HSPA), narrow band internet of things (NB-IoT) and so on. Furthermore, the communications between a terminal device and a network device in the communication network may be performed according to any suitable generation of communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. The term “communication network” may also refer to proprietary or non-standard radio systems. Embodiments of the present disclosure may be applied in various communication systems. Given the rapid development in communications, there will of course also be future types of communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a remote radio unit (RRU), a radio header (RH), a remote radio head (RRH), a relay, a low power node such as a femto, a pico, and so forth, depending on the applied terminology and technology.

As used herein, the term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but is not limited to, a mobile phone, a cellular phone, a smart phone, voice over IP (VoIP) phones, wireless local loop phones, a tablet, a wearable terminal device, a personal digital assistant (PDA), portable computers, desktop computers, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain context), a consumer electronics device, a device operating on commercial and/or industrial wireless networks, and the like. In the following description, the terms “terminal device”, “communication device”, “terminal”, “user equipment” and “UE” may be used interchangeably.

Principles and embodiments of the present disclosure will be described in detail below with reference to the accompanying drawings.

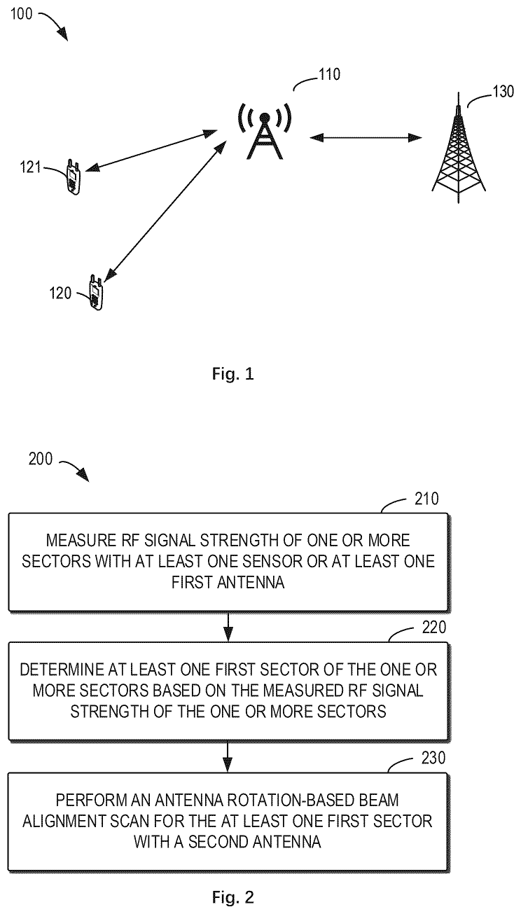

Reference is first made to FIG. 1, which illustrates an example communication system 100 in which embodiments of the present disclosure may be implemented. The communication system 100 includes an apparatus 110, a network device 130, and one or more terminal devices, such as terminal devices 120, 121. The apparatus 110 may provide connectivity between the network device 130 and the terminal devices 120,121. The apparatus 110 may be fixed wireless access (FWA) customer premises equipment (CPE), for example, 5G millimeter wave (mmW) FWA CPE. In some embodiments, the CPE may comprise one or more antennas and/or antenna arrays. The antenna array may radiate towards a reflector or a parabolic reflector. The parabolic reflector can reflect the radiated RF signals to form an antenna radiation pattern with increased antenna gain having a certain beam width. The antenna array can do electrical beam steering in an elevation plane, and/or in an azimuth plane. When the antenna array does electrical beam steering, the reflected beam is steered accordingly. An antenna system, including the antenna array and the reflector, can be rotated in the full azimuth plane of 360 degrees, or any subset of the azimuth plane. The radiated beam can be steered in the azimuth plane by rotating the entire antenna system. Typically, only the antenna part (which includes the antenna array and the reflector inside the device) may rotate, while the other parts remain static, e.g., the enclosure doesn't rotate with the antenna. Preferably, the CPE may provide a 360° field of view to connect to a signal coming from any direction, and switch between sources in the event of a temporary obstruction with RF signal loss or a connection failure. The CPE may be an indoor or an outdoor device. Example indoor devices may be self-standing devices having residential gateway (RGW) functions like WiFi and ethernet and voice ports. Example outdoor devices may be modem only devices, which are connected to separate indoor RGW devices. Outdoor devices can be e.g., mounted to walls, poles, window glass or balcony trails.

It is to be understood that the number of network devices, terminal devices or apparatus is only for the purpose of illustration without suggesting any limitations. The communication system 100 may include any suitable number of network devices 130, terminal devices 120, 121 and apparatus 110 adapted for implementing embodiments of the present disclosure.

Communications in the communication system 100 may be implemented according to any proper communication protocol(s), comprising, but not limited to, cellular communication protocols of the first generation (1G), the second generation (2G), the third generation (3G), the fourth generation (4G), the fifth generation (5G) and on, wireless local network communication protocols, such as the Institute for Electrical and Electronics Engineers (IEEE) 802.11 and the like, and/or any other protocols currently known or to be developed in the future. Moreover, the communication system 100 may utilize any proper wireless communication technology, comprising but not limited to: code division multiple access (CDMA), frequency division multiple access (FDMA), time division multiple access (TDMA), frequency division duplex (FDD), time division duplex (TDD), multiple-input multiple-output (MIMO), orthogonal frequency division multiple (OFDM), discrete Fourier transform spread OFDM (DFT-s-OFDM) and/or any other technologies currently known or to be developed in the future.

An antenna structure of the FWA CPE may consist of a conventional reflector or a reflector of a parabolic shape which is illuminated by a mmW antenna array. The mmW antenna array is mounted in front of the reflector, e.g., to an arm in front of the reflector. The antenna structure, consisting of the mmW antenna array and the reflector, can form a relatively narrow beam with a relatively high gain. Alternatively, the antenna structure may include e.g., a lens, a planar reflector surface, a metamaterial surface or equivalent which is used for substantially increasing the antenna gain. The system may also include a rotation apparatus which rotates the part of device with the mmW antenna array and the reflector in at least an azimuth plane. The rotation apparatus may comprise an electrical motor or any other apparatus that may perform e.g., manual mechanical, pneumatic, magnetic, electro-magnetic, or piezo-electric rotation. This can achieve a full 360° beam coverage or part of the coverage with relatively high gain, or any subset of the azimuth plane with relatively high gain.

Antenna beam alignment in the azimuth plane may be implemented by the antenna structure with the rotation apparatus to achieve a full azimuth plane scan, or any subset of the azimuth plane. The antenna structure, consisting of the mmW antenna array and the reflector, may form a relatively narrow beam with a relatively high gain. The antenna structure may be rotated at about 5° steps. After each step, the received RF signal strength may be measured. After the measurement, the antenna may be rotated for the best angle completing the beam alignment. The best angle may be selected based on signal strength and/or signal quality parameters, a mix of multiple parameters, or a mathematical algorithm composed and/or derived based on the parameters. The parameters may include, but are not limited to, reference signal received power (RSRP), reference signal received quality (RSRQ), modulation and coding scheme (MCS), MIMO rank, signal-to-noise ratio (SNR), signal-to-interference-plus-noise ratio (SINR), received signal strength indicator (RSSI), synchronization signal reference signal received power (SSRSRP), synchronization signal reference signal received quality (SSRSRQ), synchronization signal signal-to-interference-plus-noise ratio (SSSINR), channel state information reference signal reference power (CSI-RSRP), NR carrier received signal strength indicator (NR-RSSI), channel state information reference signal reference quality (CSI-RSRQ), downlink throughput information, uplink throughput information, or the like. Scanning the azimuth plane with the relative narrow beam can lead to long beam alignment times, and may cause service interruption when searching for a better signal while in connection.

Among others, an issue addressed by some embodiments of the present disclosure is how to shorten the time of the antenna beam alignment procedure.

According to embodiments of the present disclosure, there is provided an apparatus for antenna beam alignment. In an aspect of the apparatus, the apparatus measures the radio frequency (RF) signal strength of one or more sectors with a RF power detector. In various embodiments, the RF power detector can comprise a sensor or an antenna. The apparatus determines a first sector of the one or more sectors based on the measured RF signal strength of the one or more sectors. Directivity of the RF power detector is lower than directivity of the rotatable antenna, wherein the rotatable antenna can be the antenna structure consisting of the mmW antenna array and the reflector. With the solution as proposed herein, the time of the antenna beam alignment procedure may be shortened and the chance of service interruption may be reduced.

Reference is now made to FIG. 2, which illustrates a flowchart of an example method 200 in accordance with some embodiments of the present disclosure. For the purpose of discussion, the method 200 will be described from the perspective of the apparatus 110 of FIG. 1.

At 210, the apparatus 110 may measure the radio frequency (RF) signal strength of one or more sectors with the RF power detector, i.e. a sensor or or antenna. In some embodiments, the RF signal strength may also be referred to as RF power or RF power level. In some embodiments, the RF signal strength may be the received RF signal strength. In some embodiments, the one or more sectors may be angular sectors or azimuth plane angular sectors.

At 220, the apparatus 110 may determine a first sector of the one or more sectors based on the measured RF signal strength of the one or more sectors. In some embodiments, the first sector may be the sector from the one or more sectors with the highest measured RF signal strength. Alternatively, the first sector may be a sector in which the measured RF signal strength is higher than a threshold.

At 230, the apparatus 110 may perform an antenna rotation-based beam alignment scan for the first sector with the rotatable antenna. In some embodiments, directivity of the RF power detector (sensor or antenna) is lower than directivity of the rotatable antenna. In other words, the rotatable antenna has a narrower beam or higher gain than that of the RF power detector (sensor or antenna). The rotatable antenna may also be referred to as the second antenna, the high gain antenna, the directive antenna, or the narrow beam antenna. The rotatable antenna can be the antenna structure consisting of the mmW antenna array and the reflector. In some embodiments, the antenna rotation-based beam alignment scan may also be referred to as a fine scan.

In some embodiments, the boresight direction of the RF power detector (sensor or antenna) is aligned with the boresight direction of the rotatable antenna.

In some embodiments, the measurement or the beam alignment scan may be performed in an idle mode or an attached mode. Alternatively, the measurement may be performed without attaching to a network.

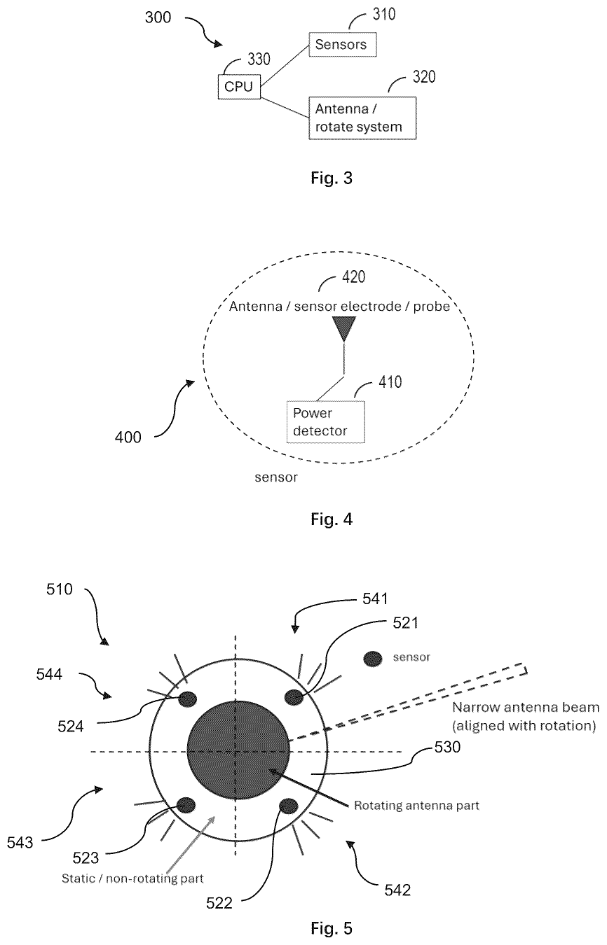

Reference is now made to FIG. 3, which illustrates an example system 300 of the apparatus 110 in accordance with some embodiments of the present disclosure. The apparatus 110 may comprise at least one RF power detector such as sensor 310, a rotatable antenna 320 connected to a rotation system (also referred to as a rotating platform), and a central processing unit (CPU) 330. The CPU 330 may connect to the RF power detector 310 and the rotating platform respectively. In some embodiments, the RF power detector 310 may comprise an electrical circuit which is capable of detecting the strength of the received RF power from the intent angular sector. For example, as shown in FIG. 4, a RF power detector sensor 400 may comprise a power diode acting as the power detector 410 and an antenna/sensor electrode/probe 420. The communication apparatus 110 may be capable of measuring the received RF signal strength for one of the one or more RF power detector sensors 400 separately if more than one RF power detector sensor 400 is included.

Reference is now made to FIG. 5, which illustrates an example top view diagram of an apparatus 510 (such as apparatus 110 in FIG. 1) in accordance with some embodiments of the present disclosure. In some embodiments, the RF power detector 310 of FIG. 3 may comprise multiple sensors 521, 522, 523, 524 each of which is placed to correspond with a sector 541, 542, 543, 544 of the multiple sectors 541, 542, 543, 544, respectively. The sensors 521, 522, 523, 523 may be placed on a non-rotating part 530 of the apparatus 510 at a location corresponding to a specific sector 541, 542, 543, 544 of the multiple sectors. The sensors 521-524 may be placed at various locations inside the apparatus 510 with respect to each other. Each one of the multiple sensors 521-524 may have a distinguishable azimuth plane angular sector 541-544 in which to detect the RF power. It is to be understood that the number of sensors 521-524 is not limited to four.

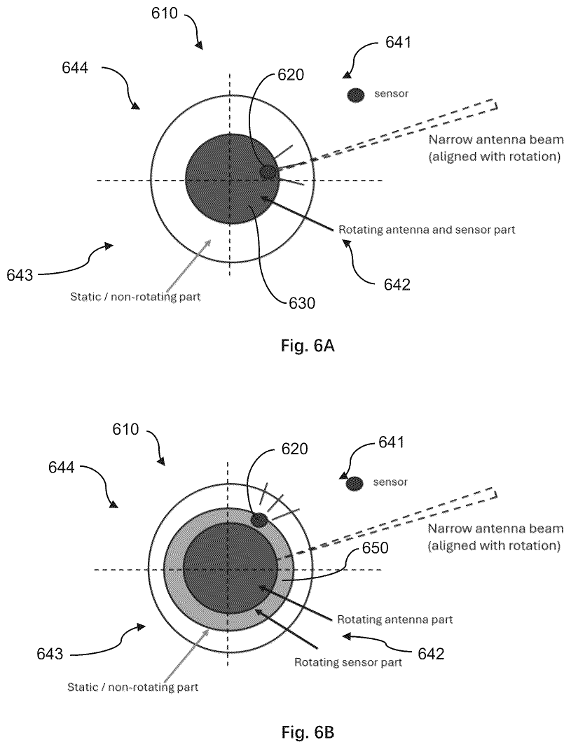

In some other embodiments, the RF power detector 310 of FIG. 3 may be configured to rotate to a sector of the multiple sectors to measure RF signal strength of the sector. Reference is now made to FIG. 6A, which illustrates an example top view diagram of an apparatus 610 (such as apparatus 110 in FIG. 1) in accordance with some embodiments of the present disclosure. The apparatus 610 may comprise one RF power detector sensor 620. The sensor 620 may be placed in the same rotatable part 630 of the apparatus 610 as the rotatable antenna (such as rotatable antenna 320 of FIG. 3). The sensor 620 may measure RF power from four sectors 641, 642, 643, 644 one at the time by rotating the sensor 620. In another example implementation of an apparatus 610 according to embodiments of the disclosure, as shown in FIG. 6B, the RF power detector sensor 620 may be placed in a different rotatable part 650 of the rotatable antenna (such as rotatable antenna 320 of FIG. 3). The sensor 620 may have lower directivity hence wider beam than that of the rotatable antenna (such as rotatable antenna 320 of FIG. 3). This may allow for faster rotation and/or using fewer rotating steps for the sensor 620 than for the rotatable antenna (such as rotatable antenna 320 of FIG. 3). It is to be understood that the number of sectors 641-644 is not limited to four, and the number of sensors 620 is not limited to one. For example, there may be two sensors, each sensor may measure one of the two sectors to achieve a relatively fast azimuth-plane scan.

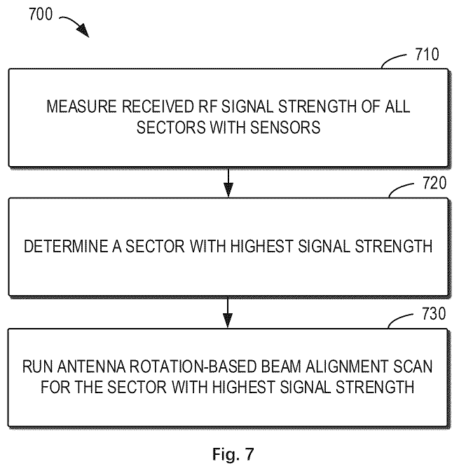

FIG. 7 shows a flowchart of an example method 700 implemented by the apparatus 110 of FIG. 1 in accordance with some embodiments of the present disclosure.

At 710, the apparatus 110 may measure received RF signal strength of all sectors with sensors. At 720, the apparatus 110 may determine the sector with the highest signal strength. At 730, the apparatus 110 may run the antenna rotation-based beam alignment scan for the sector with the highest signal strength, with the rotatable antenna 320 of FIG. 3.

This method may substantially reduce overall beam alignment time since the relatively slow antenna rotation-based beam alignment scan is done only for one sector, e.g. 90° azimuth plane sector instead of doing it for the full 360° angles of the azimuth plane in the case of four sectors.

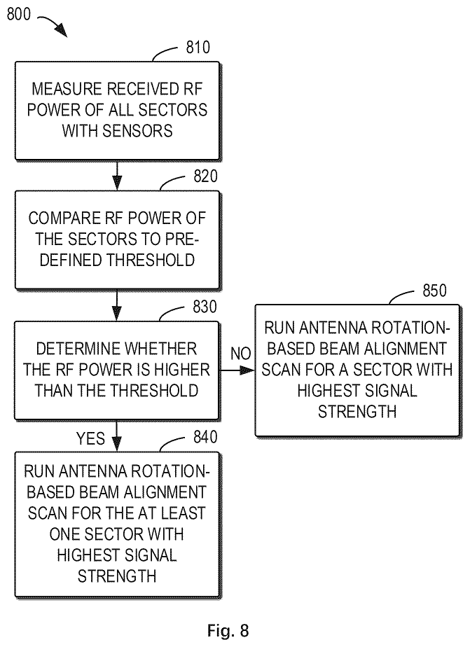

FIG. 8 shows a flowchart of an example method 800 implemented by the apparatus 110 of FIG. 1 in accordance with some embodiments of the present disclosure.

At 810, the apparatus 110 may measure the received RF power of all sectors with sensors. At 820, the apparatus 110 may compare the RF power of the sectors to a pre-defined threshold.

At 830, the apparatus 110 may determine whether the RF power is higher than the threshold. If yes, i.e. the RF power of at least one sector is higher than the threshold, the apparatus 110 may run the antenna rotation-based beam alignment scan for the at least one sector with the highest signal strength and align the rotatable antenna to the best angle, at 840. If no, i.e. no RF power is higher than the threshold, the apparatus 110 may run the antenna rotation-based beam alignment scan for the sector with highest signal strength, at 850.

This method may be useful for cases where there is more than one network cell located in different directions with respect to the first apparatus 110 providing good signal strength, as the antenna rotation-based beam alignment scan may be done for more than one sector.

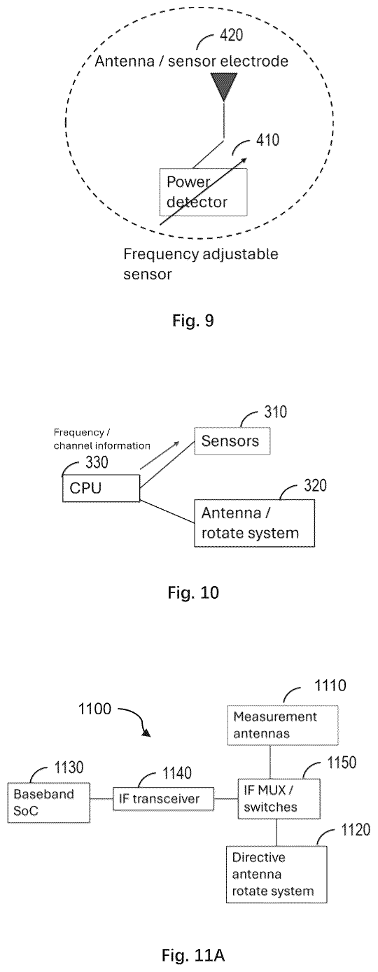

In some embodiments, the RF power detector 310 may be adjustable for operating frequency based on channel or frequency information, as shown in FIG. 9. The RF power detector 310 may have limited bandwidth and may perform measurements by adjusting the operating frequency. The CPU 330 or UE modem may adjust the operating frequency of the RF power detector 310 based on information from the CPU 330 or UE modems, such as operating band information, channel information, frequency information, etc., as shown in FIG. 10. This allows the RF power detector 310 to capture RF power from the frequency range or ranges which are relevant for modem operation at the moment.

In some embodiments, the RF power detector 310 is a high gain sensor. A structure with high gain (e.g. horn-like antennas arranged like spokes in a wheel) may be used to increase the sensitivity of the RF power detector 310. For example, the ground plane/plate may be placed behind the sensor electrode/probe as a reflector. In this way, the problem that the RF power detector 310 might not be able to detect weak signals that a main beam might still be able to pick up is reduced.

In some embodiments, the measurement may be performed without attaching to a network, as the measurement is done based on the RF power detector 310.

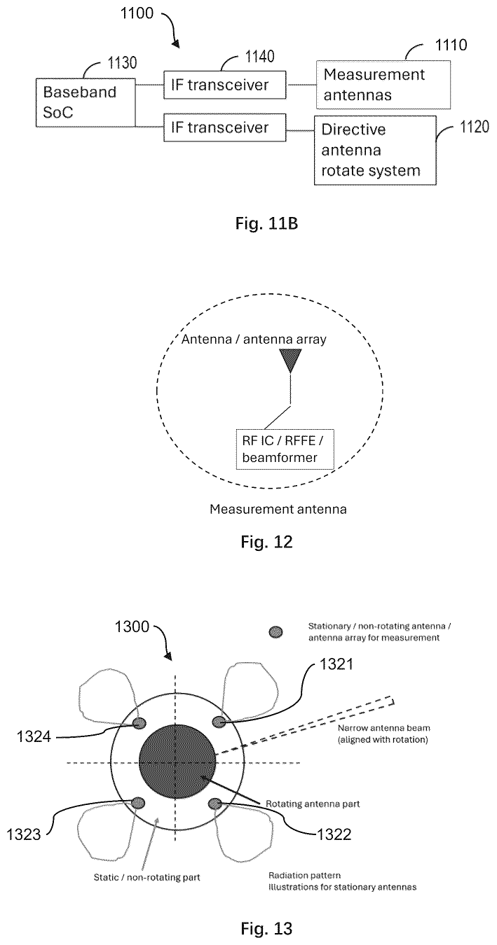

Reference is now made to FIG. 11A, which illustrates an example of an apparatus 1100 (such as apparatus 110 of FIG. 1) in accordance with some embodiments of the present disclosure. The apparatus 1100 may include an RF power detector comprising at least one measurement antenna 1110, a rotatable antenna 1120 connected to a rotation system, a baseband system-on-chip (SoC) 1130, an intermediate frequency (IF) transceiver 1140, and IF multiplexer (MUX)/switches 1150. The at least one measurement antenna 1110 may comprise an antenna or antenna array with a substantially wider beam than the rotatable antenna 1120, which may allow measurement of the RF signal strength from the intended azimuth plane angular sector, and RF integrated circuit (IC) or RF frontend (FE) or beamformer, as shown in FIG. 12. For example, in current 3GPP access UE implementations 5G F2 RF IC and RF frontends are integrated into the antenna module. The radio system for the at least one measurement antenna 1110 and the radio system for the rotatable antenna 1120 may be same. The at least one measurement antenna 1110 may use the same baseband and IF transceiver system as the rotatable antenna 1120. In some other embodiments, the radio system for the at least one measurement antenna 1110 and the radio system for the rotatable antenna 1120 may be at least partially different. There may be different IF and RF chains used for the at least one measurement antenna 1110 and the rotatable antenna 1120 as shown in FIG. 11B. This allows using either the at least one measurement antenna 1110 or the rotatable antenna 1120 without the need to switch or multiplex the IF signals.

In some embodiments, each of the at least one measurement antennas 1110 corresponds to the one or more sectors respectively. The at least one measurement antenna 1110 may be placed on a non-rotating part of the apparatus 1100. A sector of the one or more sectors is placed with a first measurement antenna of the at least one measurement antenna 1110. Reference is now made to FIG. 13, which illustrates an example top view diagram of an apparatus 1300 (such as apparatus 110 of FIG. 1) in accordance with some embodiments of the present disclosure. The apparatus 1300 comprises four measurement antennas 1321, 1322, 1323, 1324. It is to be understood that the number of measurement antennas 1321-1324 is not limited to four.

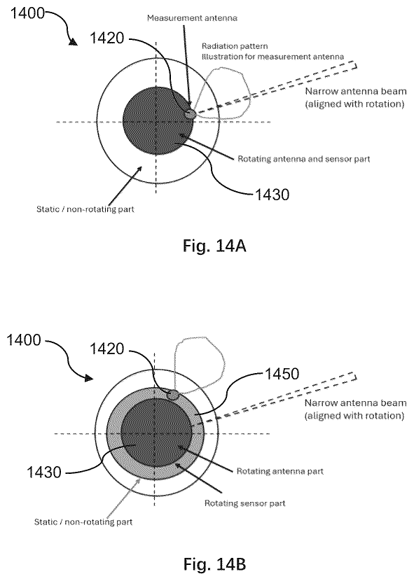

In some other embodiments, the at least one measurement antenna 1110 may be configured to rotate to a sector of the one or more sectors to measure the RF signal strength of the sector. The RF power from the one or more sectors may be measured one at the time by rotating the at least one measurement antenna 1110. Reference is now made to FIG. 14A, which illustrates an example top view diagram of the apparatus 1400 in accordance with some embodiments of the present disclosure. The apparatus 1400 may comprise one measurement antenna 1420. The measurement antenna 1420 may be placed in the same rotatable part 1430 as the rotatable antenna. For another example, as shown in FIG. 14B, the measurement antenna 1420 may be placed in a different rotatable part 1450 than the rotatable antenna. The measurement antenna 1420 may have lower directivity hence wider beam than that of the rotatable antenna. This may allow for faster rotation and/or using fewer rotating steps for the measurement antenna 1420 than for the rotatable antenna. It is to be understood that the number of sectors is not limited to four, and the number of measurement antennas 1420 is not limited to one. For example, there may be two measurement antennas, with each measurement antenna providing measurements for one of two sectors to achieve a relatively fast azimuth-plane scan.

In some embodiments, the apparatus 1400 may perform the same modem 3GPP access functionality for the at least one measurement antenna 1420 as the rotatable antenna, which means that it may, for example, perform a diverse amount of received frequency ranges (FR) 2 signal for strength and quality in the idle and attached modes.

In some embodiments, the apparatus 1400 may switch between the radio system for the at least one measurement antenna 1420 and the radio system for the rotatable antenna in a RF signal loss or a connection failure, in order to recover the system in the event of a sudden change in the radio wave propagation environment, for example, an obstacle blocking the RF path of the rotatable antenna.

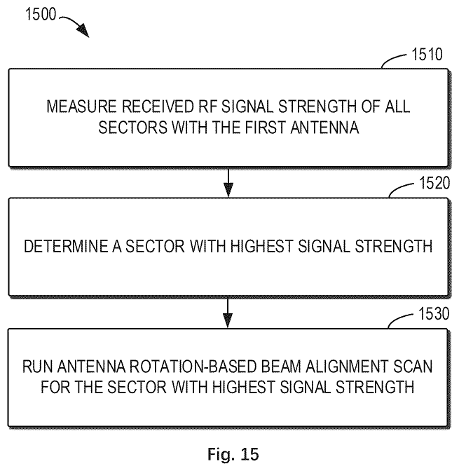

FIG. 15 shows a flowchart of an example method 1500 implemented at an apparatus (such as apparatus 110 in FIG. 1) in accordance with some embodiments of the present disclosure.

At 1510, the apparatus may measure the received RF signal strength of all sectors with the RF power detector (i.e. measurement antenna). In some embodiments, the apparatus may also measure quality parameters of the RF signal. At 1520, the apparatus may determine the sector with the highest signal strength. At 1530, the apparatus may run an antenna rotation-based beam alignment scan with the rotatable antenna for the sector with the highest signal strength.

This method may substantially reduce the overall beam alignment time since the relatively slow antenna rotation-based beam alignment scan is done only for e.g. 90° azimuth plane sector instead of doing it for the full 360° angles of the azimuth plane in the case of four sectors.

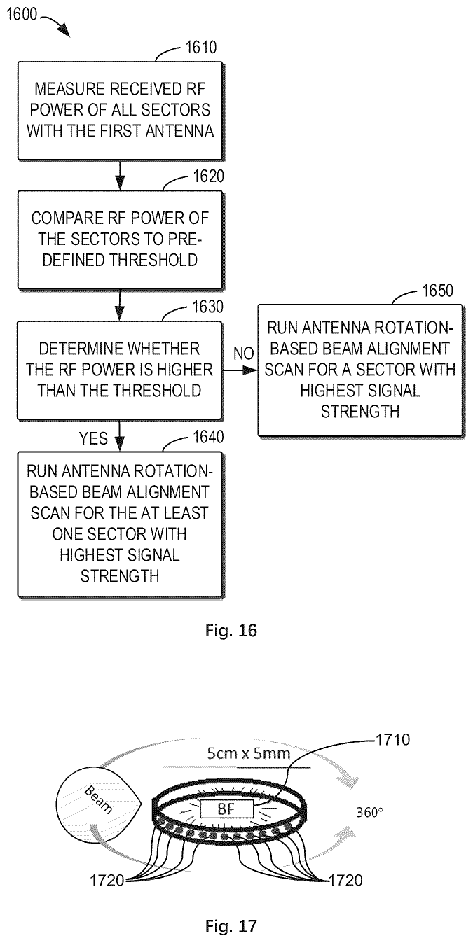

FIG. 16 shows a flowchart of an example method 1600 implemented at an apparatus (such as apparatus 110 in FIG. 1) in accordance with some embodiments of the present disclosure.

At 1610, the apparatus may measure the received RF power of all sectors with the RF power detector (i.e. measurement antenna). At 1620, the apparatus may compare RF power of the sectors to a pre-defined threshold.

At 1630, the apparatus may determine whether the RF power is higher than the threshold. If yes, i.e. the RF power of at least one sector is higher than the threshold, the apparatus may run an antenna rotation-based beam alignment scan for the at least one sector with highest signal strength and align the rotatable antenna to the best angle at 1640. If no, i.e. no RF power is higher than the threshold, the apparatus may run the antenna rotation-based beam alignment scan for a sector with the highest signal strength at 1650.

This method may be useful for cases where there is more than one network cell located in different directions with respect to the apparatus providing good signal strength, as the antenna rotation-based beam alignment scan may be done for more than one sector.

In some embodiments, the RF power detector (i.e. measurement antenna) may comprise multiple antenna elements that form a ring array. The ring array structure may be from any type of antenna elements, best suited for the given mechanics. For example, a plain round printed circuit board (PCB) with edge dipoles could provide a proper basis for beam former (BF) connections and manufacturability with low cost. A patch antenna is another example.

In some embodiments, the ring array may be used with a dedicated beam former (BF) or any structure to control the ring array beam and its direction, for example, a BF 1710 in the middle with 32 RF connections 1720 to the antenna elements, as shown in FIG. 17. The RF power detector (i.e. measurement antenna) with a dedicated BF and ring array may define the signal direction accurately without rotation and with increased sensitivity and any service interruption, while re-orienting the main beam, may be minimized. In a top tier set up, the BF with ring array may secure the connection while the main beam is fine tuned.

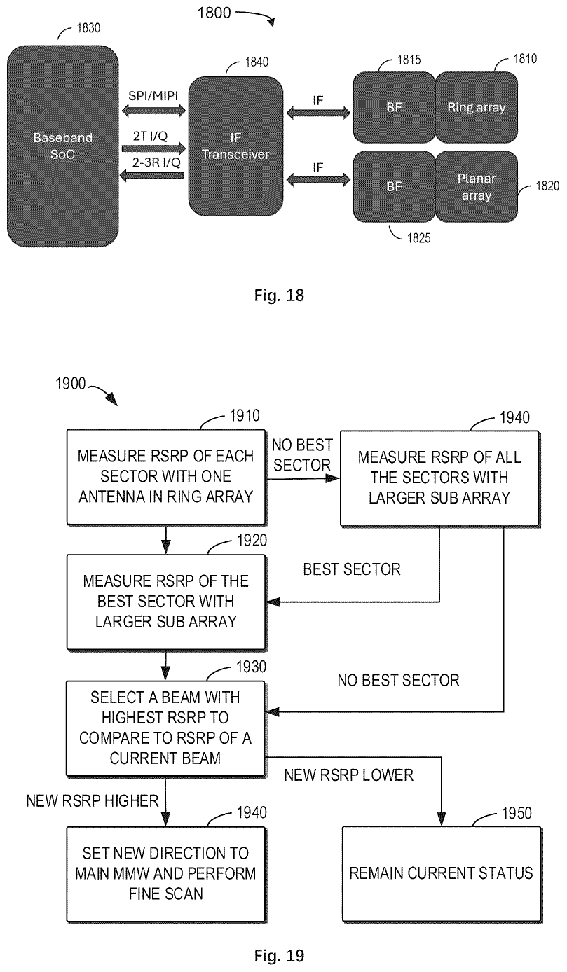

Reference is now made to FIG. 18, which illustrates an example apparatus 1800 (such as apparatus 110 in FIG. 1) in accordance with some embodiments of the present disclosure. The apparatus 1800 may comprise a ring array 1810 (measurement antenna) with a BF 1815, a planar array 1820 (rotatable antenna) with a BF 1825, a baseband SoC 1830, and an IF transceiver 1840.

In some embodiments, a sector of the one or more sectors may be measured with a subset of the multiple antenna elements. In other words, a number of antenna elements may be combined into a sub-array. The combined sub-array can be used to measure a sector.

In some embodiments, it may be common to have 32 dual polarized outputs from a mmW beam former, however, the number is not limited in this embodiment. It can provide a proper angular selectivity and gain when a subset of multiple antenna elements of the ring array (such as ring array 1820 in FIG. 18) is used. When RSRP is used to define the signal level, the V and H polarizations can be divided to cover different parts of the 360°, since one polarization stream is enough to define the best level of the signal. The gain would remain the same over the 360° horizontal or azimuth scan when the same number of array elements are used in the subset of the ring array.

In some embodiments, the size of the one or more sectors measured with subsets of the multiple antenna elements is adjusted depending on the number of the multiple antenna elements in the subset. In other words, for the azimuth plane scan, the number of the one or more sectors is adjusted depending on the number of the multiple antenna elements in the subset of the ring array, as the number of the one or more sectors is inter-related to the size of the one or more sectors. The size of the one or more sectors is related to the beamwidth formed by the subset of the ring array, depending on the number of multiple antenna elements used in the subset.

To increase scanning speed, different array sizes with different horizontal half power beam width (HPBW) may be selected. FIG. 19 shows a flowchart of an example method 1900 implemented at the apparatus 1800 of FIG. 18 in accordance with some embodiments of the present disclosure.

At 1910, the apparatus 1800 may measure the RSRP of a sector with one antenna in the ring array 1810. For example, the apparatus 1800 may start the measurement with a full range coarse sweep with one antenna that covers 90° vertically and horizontally.

If there is a best sector, the apparatus 1800 may measure the RSRP of the best sector with larger sub array in step 1920. At 1930, the apparatus 1800 may select a beam with the highest RSRP to compare to the RSRP of the current beam.

If there is no best sector, the apparatus 1800 may measure the RSRP of all of the sectors with a larger sub array, from a sub array size of 1×2 to 1×X in step 1940. For example, an array of two with 45° coverage horizontally and so forth until the max array size for the maximum selectivity and gain is achieved. If there is a best sector, then skip to 1920, else if the max sub array size has been achieved, skip to 1930.

If a result of the comparation of 1930 is that the new RSRP is higher, the apparatus 1800 may set a new direction for the main mmW and perform a fine scan at 1940. Otherwise, i.e. if the result of the comparation of 1930 is that the new RSRP is lower, the apparatus 1800 may remain in its current status as shown in step 1950.

In some embodiments, the RF power detector measurement antenna may further be configured to serve as a main or a secondary transceiver. For example, the RF power detector measurement antenna may serve as the main mmW transceiver, if appropriate BF is selected. In a beam refinement stage, electrical beams are scanned while connection to the cell is already established.

In some embodiments, the RF power detector measurement antenna may further be configured to form a diversity or a multiple-input multiple-output (MIMO) antenna of the rotatable antenna.

In some embodiments, an apparatus capable of performing method 200 (for example, the apparatus 110 of FIG. 1) may comprise means for performing the respective steps of method 200. The means may be implemented in any suitable form. For example, the means may be implemented in circuitry or a software module.

In some embodiments, the apparatus comprises: means for measuring the RF signal strength of one or more sectors with a RF power detector; means for determining, at least one first sector of the one or more sectors based on the measured RF signal strength of the one or more sectors; and means for performing an antenna rotation-based beam alignment scan for the at least one first sector with a rotatable antenna, wherein directivity of the RF power detector has a lower directivity than that of the rotatable antenna.

In some embodiments, the at least one first sector is the sector of the one or more sectors with the highest measured RF signal strength. Alternatively, the at least one first sector can be a sector having a measured RF signal strength that is higher than a threshold.

In some embodiments, a sector of the one or more sectors is placed with a sensor or antenna of the RF power detector.

In some embodiments, the RF power detector is configured to rotate to a sector of the one or more sectors to measure the RF signal strength of the sector and is placed on the same rotatable part as the rotatable antenna. Alternatively, the RF power detector can be placed on a different rotatable part than the rotatable antenna.

In some embodiments, the boresight direction of the RF power detector is aligned with the boresight direction of the rotatable antenna.

In some embodiments, the measurement or the beam alignment scan is performed in an idle mode or an attached mode. Alternatively, it can be performed without attaching to a network.

In some embodiments, the measurement antenna of an RF power detector comprises multiple antenna elements that form a ring array, wherein a sector of the one or more sectors is measured with a subset of the multiple antenna elements.

In some embodiments, the size of the one or more sectors measured with subsets of the multiple antenna elements is adjusted depending on the number of the multiple antenna elements of the subset.

In some embodiments, a radio system for the measurement antenna of the RF power detector and the radio system for the rotatable antenna are the same or at least partially different.

In some embodiments, the apparatus further comprises means for switching between the radio system for the measurement antenna of the RF power detector and the radio system for the rotatable antenna in the event of a RF signal loss or a connection failure.

In some embodiments, the measurement antenna of the RF power detector is further configured to form a diversity or a MIMO antenna of the rotatable antenna.

In some embodiments, the measurement antenna of the RF power detector is further configured to serve as a main or a secondary transceiver.

In some embodiments, the sensor of a RF power detector is adjustable for operating frequency based on information of channel or frequency.

In some embodiments, the apparatus further comprises means for performing other steps in some embodiments of the method 200. In some embodiments, the means comprises at least one processor and at least one memory including computer program code, the at least one memory and computer program code configured to, with the at least one processor, cause the performance of the apparatus.

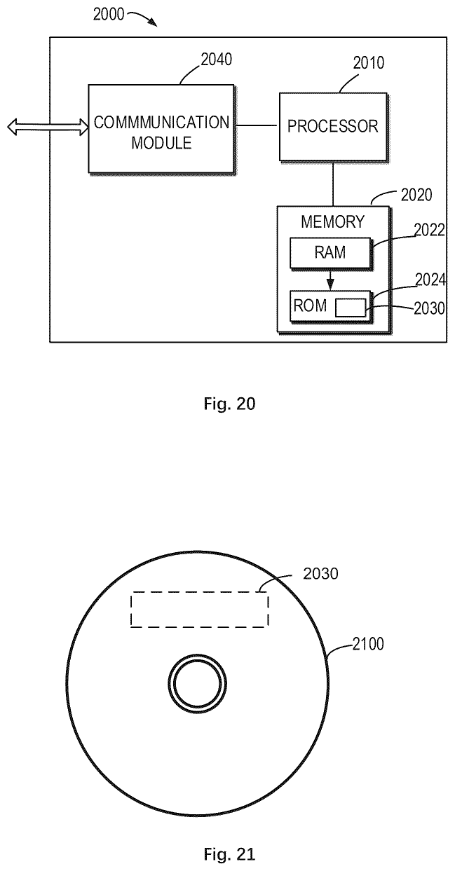

FIG. 20 is a simplified block diagram of a device 2000 that is suitable for implementing embodiments of the present disclosure. The device 2000 may be provided to implement the apparatus, for example the apparatus 110 as shown in FIG. 1. As shown, the device 2000 includes one or more processors 2010, one or more memories 2020 coupled to the processor 2010, and one or more communication modules 2040 coupled to the processor 2010.

The communication module 2040 can be used for bidirectional communications. The communication module 2040 has at least one antenna to facilitate communication. The communication interface may represent any interface that is necessary for communication with other network elements.

The processor 2010 may be of any type suitable to the local technical network and may include one or more of the following: general purpose computers, special purpose computers, microprocessors, digital signal processors (DSPs) and processors based on multicore processor architecture, as non-limiting examples. The device 2000 may have multiple processors, such as an application specific integrated circuit chip that is slaved in time to a clock which synchronizes the main processor.

The memory 2020 may include one or more non-volatile memories 2024 and one or more volatile memories 2022. Examples of the non-volatile memories 2024 include, but are not limited to, read only memory (ROM), an electrically programmable read only memory (EPROM), a flash memory, a hard disk, a compact disc (CD), a digital video disk (DVD), and other magnetic storage and/or optical storage. Examples of the volatile memories 2022 include, but are not limited to, random access memory (RAM) and other volatile memories that will not last in the power-down duration.

A computer program 2030 that includes computer executable instructions that are executed by the associated processor 2010, may be stored in the ROM 2024. The processor 2010 may perform any suitable actions and processing by loading the program 2030 from ROM 2024 into the RAM 2022.

The communication module 2040 is for bidirectional communications. The communication module 2040 has at least one antenna to facilitate communication. The communication interface may represent any interface that is necessary for communication with other network elements.

The embodiments of the present disclosure may be implemented by means of the computer program 2030 so that the device 2000 may perform any process of the disclosure as discussed with reference to FIGS. 2 to 19. The embodiments of the present disclosure may also be implemented by hardware or by a combination of software and hardware.

In some embodiments, the computer program 2030 may be tangibly contained in a computer readable medium which may be included in the device 2000 (such as in the memory 2020) or other storage devices that are accessible by the device 2000. The device 2000 may load the computer program 2030 from the computer readable medium into RAM 2022 for execution. The computer readable medium may include any type of tangible non-volatile storage, such as ROM, EPROM, a flash memory, a hard disk, CD, DVD, and the like. FIG. 21 shows an example of the computer readable medium 2100 in the form of a CD or DVD. The computer readable medium 2100 has the computer program 2030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique, or method described herein may be implemented in, as non-limiting examples, hardware, software, firmware, special purpose circuits or logic, general purpose hardware, or controller, or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to FIGS. 2-19. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but is not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not to be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus comprising:
a RF power detector;
a rotatable antenna, wherein directivity of the RF power detector is lower than directivity of the rotatable antenna;
a processor; and
a memory storing instructions that, when executed by the processor, cause the apparatus to:
measure radio frequency (RF) signal strength of one or more sectors with the RF power detector;
determine a first sector of the one or more sectors based on the measured RF signal strength of the one or more sectors; and
perform an antenna rotation-based beam alignment scan for the first sector with the rotatable antenna;
wherein a sector of the one or more sectors is placed with a sensor of the RF power detector.

2. The apparatus of claim 1, wherein the RF power detector is a sensor.

3. The apparatus of claim 1, wherein the RF power detector is a measurement antenna.

4. The apparatus of claim 1, wherein the first sector is a sector of the one or more sectors with the highest measured RF signal strength.

5. The apparatus of claim 1, wherein the first sector is a sector of the one or more sectors having a measured RF signal strength that is higher than a threshold.

6. The apparatus of claim 1, wherein the RF power detector is configured to rotate to a sector of the one or more sectors to measure RF signal strength of the sector.

7. The apparatus of claim 6, wherein the RF power detector is placed in a same rotatable part as the rotatable antenna.

8. The apparatus of claim 6, wherein the RF power detector is placed in a different rotatable part than the rotatable antenna.

9. The apparatus of claim 6, wherein a boresight direction of the RF power detector is aligned with a boresight direction of the rotatable antenna.

10. The apparatus of claim 1, wherein the beam alignment scan is performed in an idle mode.

11. The apparatus of claim 1, wherein the beam alignment scan is performed in an attached mode.

12. The apparatus of claim 1, wherein the beam alignment scan is performed without attaching to a network.

13. The apparatus of claim 3, wherein the first antenna comprises multiple antenna elements that form a ring array, wherein a sector of the one or more sectors is measured with a subset of the multiple antenna elements.

14. The apparatus of claim 13, wherein a size of the one or more sectors measured with the subset of the multiple antenna elements is adjusted depending on a number of the multiple antenna elements of the subset.

15. The apparatus of claim 3, wherein a radio system for the first antenna and a radio system for the rotatable antenna are the same.

16. The apparatus of claim 3, wherein a radio system for the first antenna and a radio system for the rotatable antenna are at least partially different.

17. The apparatus of claim 16, wherein the apparatus is further caused to switch between the radio system for the first antenna and the radio system for the rotatable antenna during a RF signal loss or a connection failure.

18. The apparatus of claim 3, wherein the first antenna is further configured to form a diversity or a multiple-input multiple-output (MIMO) antenna of the rotatable antenna.

19. The apparatus of claim 3, wherein the first antenna is further configured to serve as a main or a secondary transceiver.

20. The apparatus of claim 2, wherein the sensor is adjustable for operating frequency based on information of channel or frequency.

21. A method comprising:
measuring radio frequency (RF) signal strength of one or more sectors with a RF power detector;
determining a first sector of one or more sectors based on a measured RF signal strength of the one or more sectors; and
performing an antenna rotation-based beam alignment scan for the first sector with a rotatable antenna, wherein directivity of the RF power detector is lower than directivity of the rotatable antenna.
